(19) United States
(12) Patent Application Publication
(10) Pub. No.: US 2023/0367133 A1
(43) Pub. Date: Nov. 16, 2023

(54) MULTI BROADBAND COAXIAL LASER BEAM COMBINER APPARATUS AND METHODS

(71) Applicant: The United States of America, as represented by the Secretary of the Navy, Crane, IN (US)

(72) Inventors: Marshall A. Mullins, Bloomington, IN (US); Charles R. Upton, Jasper, IN (US)

(73) Assignee: The United States of America, as represented by the Secretary of the Navy, Arlington, VA (US)

(21) Appl. No.: 18/196,561

(22) Filed: May 12, 2023

Related U.S. Application Data
(60) Provisional application No. 63/341,227, filed on May 12, 2022.

(51) Int. Cl. G02B 27/10; G02B 27/14; G02B 27/09; G02B 26/08

(52) U.S. Cl. CPC G02B 27/1006; G02B 27/141; G02B 27/0977; G02B 26/0833

(57) ABSTRACT

Provided is a broadband multi-line laser beam combiner apparatus and method that allows a broader spectrum of light to be emitted from a single optical path. The disclosed apparatus and method provide the ability to combine a number of unique laser lines including both visual and infrared light as one optical beam that is emitted from a single emission aperture or window using both conventional dichroic mirrors and an imaging dichroic mirror. The apparatus and method are based, in part, on an optical material selection and design that affords the ability to combine multiple broadband laser sources. Rather than merely emitting discrete laser lines, the presently disclosed broadband multi-line laser beam combiner can emit an “ultra-wide-continuum” of wavelengths from approximately 400 nm to 5000 nm at emitted optical powers greater than five (5) Watts from one emission aperture/window.

### CROSS-REFERENCE TO RELATED APPLICATIONS

The present application claims priority to and the benefit of U.S. Provisional Patent Application Ser. No. 63/341,227 filed May 12, 2022, and entitled “MULTI BROADBAND COAXIAL LASER BEAM COMBINER APPARATUS AND METHODS,” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 21085815502) is assigned to the United States Government and is available for licensing for commercial purposes. Licensing and technical inquiries may be directed to the Technology Transfer Office, Naval Surface Warfare Center Crane, email: Crane_T2@navy.mil.

### FIELD

The field of invention relates generally to laser emissions, and more particularly to apparatus and methods for combining different laser light spectra into one beam of laser light.

### BACKGROUND

Broadband laser sources (e.g., a laser source that emits light wavelengths from approximately 500 nm to 700 nm) are an emerging technology that has been developed by the Department of Defense over the past 10 years. Prior to broadband laser sources or emission, a multi-line laser combination was the only way to achieve a laser emission of more than one discrete wavelength. Additionally, beam-combining two separate allocations of optical wavelengths of the electromagnetic spectrum (EMS), such as visible light (i.e., Electro-Optical (EO)) light having wavelengths approximately 400 nm to 700 nm) and mid-wave infrared (MWIR) (i.e., infrared light from approximately between 3,000 nm and 5,000 nm) was not a technique that has been used. Most laser optics are coated with anti-reflective coatings for enabling better efficiencies at the specific wavelengths being used, such that optics that will work for the visible spectrum do not have specifications or capabilities for other wavelengths.

### SUMMARY

The present disclosure relates to a broadband multi-line laser beam combiner that allows a broader spectrum of light to be emitted from a single optical path. The disclosed apparatus and methods provide the ability to combine multiple unique laser lines (e.g., four laser lines) as one optical beam that is emitted from a single emission aperture or window. The apparatus and methods are based, in part, on an optical material selection and design that affords the ability to combine the multiple broadband laser sources. Accordingly, rather than merely emitting separate and discrete laser lines, the presently disclosed broadband multi-line laser beam combiner can emit an “ultra-wide-continuum” of wavelengths from approximately 400 nm to 5000 nm at emitted optical powers greater than five (5) Watts from one emission aperture/window.

According to one aspect, a broadband multi-line laser is disclosed including a first mirror configured to reflect a first range of wavelengths of light and pass a second range of wavelengths of light such that light beams emitted from two light sources directed at the first mirror at incident angles approximately perpendicular to one another are additively combined and emitted from the first mirror. The broadband multi-line laser further includes a first laser light source aimed at the first mirror and configured to emit a first light beam at at least one first wavelength within the first range of wavelengths, and a second laser light source aimed at the first mirror at an angle approximately perpendicular to the first light source and configured to emit a second light beam at at least a second wavelength within the second range of wavelengths of light such that the first and second light beams combine into a combined light beam. Moreover, the broadband multi-line laser includes a second mirror configured to receive and direct the combined light beam for output emission by the broadband multi-line laser.

In another aspect, a multi broadband laser is disclosed including at least a first dichroic mirror configured to additively combine light emitted from two or more visible or electro-optic (EO) light sources. The multi broadband laser further includes a first visible or EO light source and a second visible or EO light source both aimed at the at least one first dichroic mirror such that a first light beam from the at least a first visible or EO light source and a second light beam from a second visible or EO light source are additively combined into a first combined light beam. Moreover, the multi broadband laser features a first imaging dichroic mirror configured to additively combine light emitted from visible or electro-optic (EO) light sources and at least one infrared light source and placed to receive the first combined light beam from the at least a first dichroic mirror. Finally, the multi broadband laser includes an infrared light source aimed at the first imaging dichroic mirror such that a third light beam emitted by the infrared light source is additively combined with the first combined light beam by the first imaging dichroic mirror to output a multi broadband laser beam.

According to still another aspect, a method for broadband multi-line laser transmission is disclosed. The method includes directing at least one visible/EO laser beam from at least one visible/EO laser source toward at least one imaging mirror, directing at least one broadband laser beam from at least one broadband IR laser source (e.g., SWIR, toward the at least one imaging mirror for additively combining the at least one visible/EO laser beam and the at least one broadband laser beam to form a resultant multi-broadband beam, and outputting the resultant multi-broadband beam for transmission.

According to yet another aspect, a broadband multi-line laser is disclosed including a plurality of light or laser sources each having respective different wavelengths, one or more first light or laser combining means configured to combine a first portion of the plurality of light or laser sources, at least a second light or laser combining means configured to combine the combined first portion of the light or laser sources and a remainder portion of the plurality of light or laser sources, wherein the second light or laser combining means is configured to combine differently from the one or more first light or laser combining means, and a steering means or mirror configured to receive and direct the combined first portion of the light or laser sources and the remainder portion of the plurality of light or laser sources for output emission.

### BRIEF DESCRIPTION OF THE DRAWINGS

The detailed description herein particularly refers to the accompanying figures in which:

FIG. 1 shows a system diagram of an exemplary multi-line laser apparatus according to some aspects of the disclosure.

FIG. 2 shows a system diagram of another exemplary multi-line laser apparatus according to some aspects of the disclosure.

FIG. 3 illustrates a flow diagram of a method for operating a multi-line laser apparatus according to some aspects of the disclosure.

### DETAILED DESCRIPTION

The embodiments or examples of the invention described herein are not intended to be exhaustive or to limit the invention to the precise forms disclosed. Rather, the embodiments or examples selected for description have been chosen to enable one skilled in the art to practice the invention.

While multi-line laser beam combination is known, the ability to combine different allocations of the electromagnetic spectrum (EMS), such as visible or electro-optical (EO) (e.g., 400 nm-700 nm), short wavelength infrared (SWIR) (e.g., 700 nm-2000 nm) and medium wavelength infrared (MWIR) (e.g., 3000 nm-5000 nm) required a non-traditional laser optic. The present disclosure provides a multi broadband coaxial laser beam combiner apparatus and methods capable of combining different allocations to emit an “ultra-wide-continuum” of approximately 400 nm to 5000 nm from one laser aperture or window at optical powers greater than five (5) Watts.

In particular, the presently disclosed apparatus and methods utilize an imaging optic (i.e., not a laser optic) to beam combine EO and MWIR wavelengths. The methodology includes, in some further aspects, providing dichroic mirrors (i.e., a mirror that is transparent to one wavelength, but reflective to another wavelength, and operating as a laser optic) to combine multiple visible EO wavelengths and then, in turn, combine those combined EO wavelengths with MWIR wavelength using the imaging optic, which may be another type of dichroic mirror in some examples. Accordingly, the present disclosure advances laser technology from monochromatic laser emission to broadband laser emission at high optical power. Moreover, the present disclosure provides a system that can handle high optical powers of multiple monochromatic lasers that are combined with one or more broadband lasers from different EMS allocations coaxially as a single emitted laser beam.

In more detail, the present disclosure allows for the coaxial beam combination of two broadband laser systems (e.g., a visible/EO laser 400 nm-1000 nm), and an Infrared laser (e.g., wavelengths of 1000 nm-5000 nm) via the use of an imaging dichroic mirror that was originally designed for camera usage (i.e., not originally intended for high optical power to be used on or through the surface of the mirror). Additionally, the presently disclosed apparatus and methods allow monochromatic lasers (i.e., traditional, non-broadband lasers) to be combined with laser optics (e.g., dichroic mirrors). Furthermore, the present invention is compatible with different and multiple laser types. However, it is noted that the use of fiber optic lasers may be beneficial to keep the footprint of the beam combiner apparatus smaller. Additionally, using a fiber laser allows for placement of the laser module (i.e., that are water-cooled) in a stationary location. This allows the beam combiner box to be placed on a pan/tilt without exceeding the pan/tilt balanced weight limits. The present invention also may utilize a fast steering mirror (FSM) to raster the lasers through physical space after they have been coaxially beam combined at the imaging optic.

It is noted that dichroic mirrors or optics, which are utilized in the presently disclosed apparatus and methods, are utilized for combining two light sources. Dichroic mirrors/optics have properties wherein particular EO/IR light wavelengths across a spectrum of wavelength are either transmitted or reflected by a particular dichroic mirror. Thus, for example, a particular dichroic mirror might pass light having wavelengths approximately between 350 nm and 500 nm through the mirror (e.g., blue light), but reflect light having wavelengths below 350 nm (e.g., UV or violet light) and greater than 500 nm (e.g., green or red light).

Moreover, the properties of dichroic mirrors (also known as beam splitters for the reverse operation (i.e., reverse of beam combination) or wavelength pass filters) allow for the combination/overlap of two or more laser sources. For example, a dichroic mirror will be act as a transparent window to a blue laser (e.g., 450 nm) and reflective to a green laser (e.g., 532 nm). Dependent on the physical set up of an optic apparatus, the mirror can then combine the laser sources by overlapping the beams (e.g., one beam from a first light source passes through or is transmitted by the dichroic mirror and another beam from another light source positioned 90 degrees of rotation from the first light source is reflected by the mirror into the same direction as the other beam transmitted through the mirror) and cause a camera or the human eye to observe different color, which in this case of blue and green lasers might be a cyan color. Similarly, combining a green laser (e.g., 532 nm) with a red laser (e.g., 637 nm) will cause a camera or human eye to observe a yellow color. Furthermore, combining a blue laser (e.g., 450 nm) with a red laser (e.g., 637 nm) will cause a camera or the human eye to observe a magenta color. Finally, by using more than one dichroic mirror/optic with more than two light sources (e.g., a blue laser (450 nm), a green laser (532 nm) and a red laser (637 nm)), the resultant combined beam causes a camera or the human eye to observe another color of light, which in the case of blue, green, and red lasers would be “White Light.”

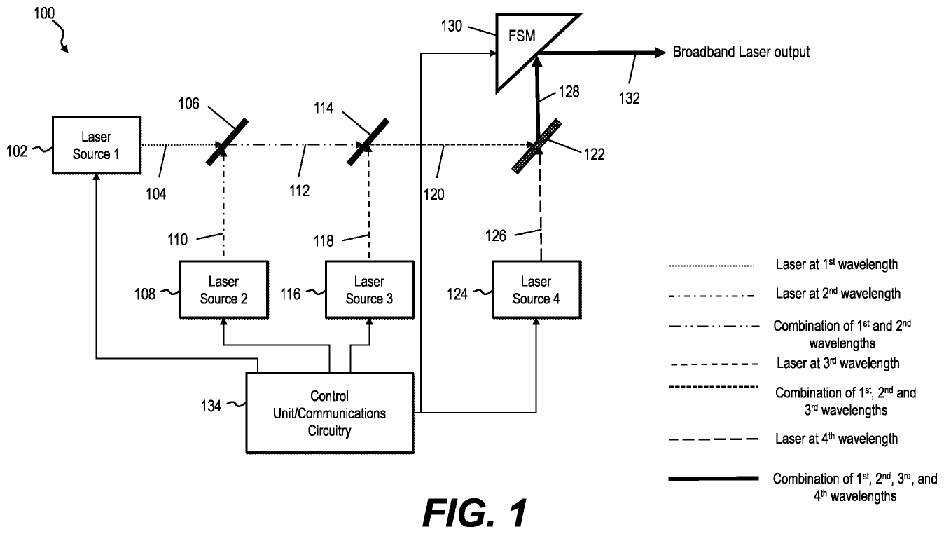

Turning to the drawings, FIG. 1 shows a system diagram of an exemplary multi-line laser apparatus 100 according to some aspects of the disclosure. In this example, multiple visible light lasers are included and the beams therefrom are combined before being combined with another type of laser, such as an MWIR laser. As shown, the apparatus 100 includes a first laser source 102 that emits a first laser beam 104 of a first wavelength toward a first dichroic mirror 106. A second laser source 108 emitting a second laser beam 110 of a second wavelength is also directed at first dichroic mirror 106. The result is a combination of the two laser beams as shown by output laser beam 112. It is noted that beam 112 is an addition of the beams 104 and 110 and results in a combination of the two wavelengths, which results in a different color due to the physical phenomena of additive color mixing (e.g., mixing light sources to create different colors).

Further, the beam 112 is directed at a second dichroic mirror 114, which is disposed in a light path between the first dichroic mirror 106 and an imaging dichroic mirror 122 that will be discussed in more detail below. The mirror 114 is also positioned to receive a third laser beam 118 from a third laser source 116. The result of this arrangement is yet another combination laser beam 120, which is a combination of the three wavelengths and results in yet a different color due to additive color mixing.

Next, the combination laser beam 120 is directed toward a third mirror device 122 that combines the combined beam 120 with a laser beam 126 of at least a fourth wavelength from laser source 124. In one aspect, it is noted that beam 126 is not visible light, but instead is infrared (IR), such as SWIR, MWIR, or even long wavelength infrared (LWIR). It is noted that the third mirror device 122 is configured as an imaging optic (i.e., not necessarily as a traditional laser optic), and serves to be enable combination of a visible light beam (e.g., beam 120 if configured as visible light) with IR electromagnetic emissions in some aspects. In one example, the third mirror device 122 is a dichroic mirror that is configured to reflect visible light (e.g., beam 120) and pass infrared (IR) including both LWIR and MWIR, as well as short wave infrared (SWIR) (e.g., 1000 nm to 3000 nm), which results in a combined visible and IR beam (e.g., beam 128) and is termed herein as an “imaging dichroic mirror” that is different from the other dichroic mirrors (e.g., 106, 114, which are more conventional or traditional laser optics). In further aspects, an imaging dichroic mirror (e.g., third mirror device 122) may be implemented with imaging mirror devices that allow multiple cameras, for example, to image at the same time from different optical bands of the electromagnetic spectrum (e.g., visual light combined with IR such as SWIR or MWIR), and used in this example application to combine the beam 120 (e.g., combined visual laser beam of one or more visual light wavelengths) and beam 126 (e.g., one or more IR laser wavelengths) for creation of a multi broadband laser beam.

The combination of the laser emissions by the mirror 122 is shown by combined beam 128, which may be directed to a fast steering mirror (FSM) 130 in some aspects. The FSM 130 is configured to directing the output emission of a beam 132 of the combined lasers. In one example, FSM 130 may be a traditional mirror that is mounted to electromagnetic actuators (e.g., three piezo elements) that allow the mirror to be rapidly moved in precise, repeatable, and programmable patterns. The FSM 130 allows the laser apparatus 100 to rapidly transition from side to side (or up and down, or in a circle), as well as stabilize beam jitter for long range applications. In an aspect, the apparatus 100 of FIG. 1 is beneficial for systems requiring both visible and IR lasers, as all of the lasers may be combined in one system, rather than using separate laser systems to provide the various spectra in one output beam. It is noted that, in some aspects, if steerability or direction of the combination beam 128 is not needed, some embodiments may not need to utilize FSM 130 and combined beam 128 may constitute the output light beam of the apparatus 100.

In further aspects, the apparatus 100 of FIG. 1 may include a control unit/communications circuitry 134 that is configured to control the laser sources (e.g., on/off, wavelength selection/adjustment) and FSM 130. According to some other aspects, the circuitry 134 may be used to modulate communications information using the laser sources and/or FSM 130 to be transmitted over the broadband laser output 132 for applications in telecommunications.

According to some further aspects, the apparatus 100 may utilize commercial-off-the-shelf (COTS) lasers. One embodiment utilizes a 10 Watt Blue Fiber Laser, a 10 Watt Green Fiber Laser, a 10 Watt Red Fiber laser, and a 10 Watt Mid-Wave Infrared Quantum Cascade Laser as an example. Additionally, COTS broadband lasers may be utilized, wherein such lasers emit not just one wavelength of light, but thousands of wavelengths without a significant gap of coverage. Examples include a visible broadband fiber laser and a medium wavelength infrared (MWIR) laser. The present invention affords beam-combining of one or more of such broadband laser sources.

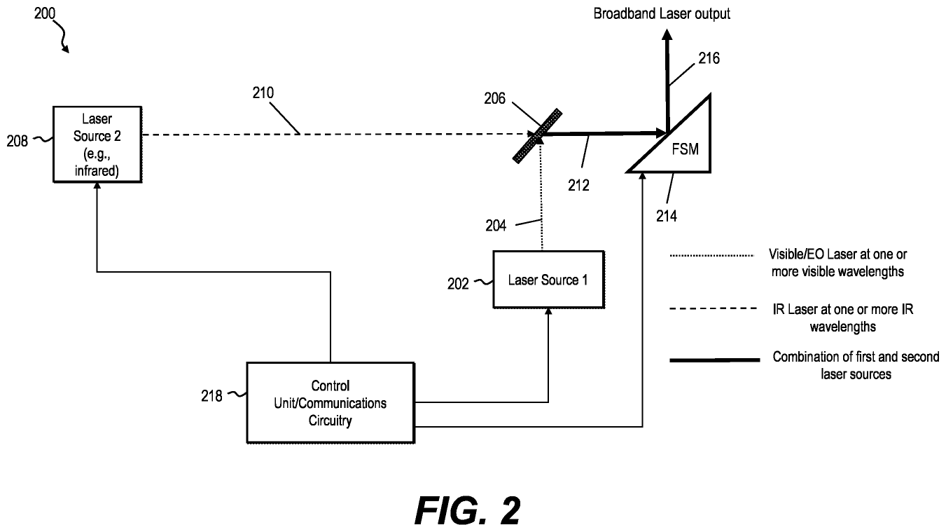

It will be appreciated by those skilled in the art that the presently disclosed broadband multi-line laser apparatus, in some aspects, may be constructed to simply combine a visible light source and an IR light source with at least one imaging dichroic mirror configured to reflect a first range of wavelengths of light and pass a second range of wavelengths of light such that light beams emitted from two light sources directed at the mirror at incident angles approximately perpendicular to one another are additively combined and emitted from the mirror to achieve an additive, combined light beam. Accordingly, FIG. 2 shows another example of a multi-line laser apparatus 200 combining two light sources according to aspects of the disclosure. In this example, rather than combining multiple visible/EO sources, only one visible or EO laser source termed “laser source 1” and shown at 202 is used. In this example, laser light source 202 emits a beam 204 of visible/EO light at one or more wavelengths toward a first mirror 206. In this example, first mirror 206 is not a traditional laser optic, but rather an imaging optic such as with mirror 122 (e.g., imaging dichroic mirror), as discussed above. The system of FIG. 2 further includes a second laser light source 208, which is operable to provide a laser beam 210 at IR wavelengths (e.g., LWIR and/or MWIR, as well as SWIR), although not limited to such. The mirror 206 combines beams 204 and 210 into a broadband coaxial combination beam 212 and directs the beam to an FSM 214 similar to FSM 130 discussed above, and then output a steered beam 216. It is noted that, in some aspects, if steerability or direction of the combination beam 212 is not needed, some embodiments may not need to utilize FSM 214 and combined beam 212 then constitutes the output light beam of the apparatus 200.

As further shown in FIG. 2, the apparatus 200 may include a control unit/communications circuitry 218 configured to modulate communications information via control of the laser sources 202 and 208, as well as FSM 214 to be carried over broadband laser output 216. It is also noted that the angle orientations of the first and second laser light sources 202, 208 with respect to the first mirror 206 are merely exemplary, and alternatively the positions could be reversed where the optics of first mirror 206 are configured such that the IR wavelength light beam is reflected at approximately 90 degrees and the visible/EO wavelength light beam is passed by mirror 206.

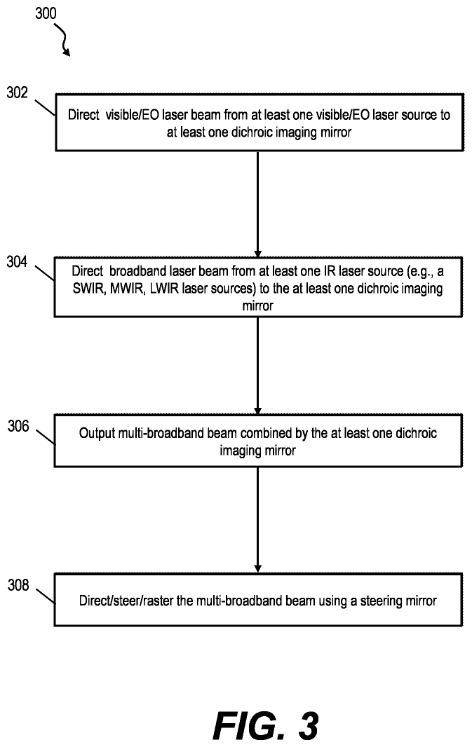

FIG. 3 illustrates a flow diagram of a method 300 for operating a multi-line laser apparatus according to some aspects of the disclosure. As illustrated, method 300 includes directing at least one visible/EO laser beam from at least one visible/EO laser source to at least one imaging mirror (e.g., imaging dichroic mirrors 122 or 206 shown in FIGS. 1 and 2) as shown at block 302. Further, method 300 includes directing a broadband laser beam (e.g., an IR laser) from at least one broadband IR laser source (e.g., SWIR, MWIR, LWIR, or a configurable/selectable IR laser source) to or toward the at least one imaging mirror (e.g., 122 or 206) as shown at block 304. Finally, method 306 includes outputting the resultant multi-broadband beam combined by the at least one imaging mirror as shown at block 306. The method 300 may further include a process shown in block 308 of using or incorporating a steering mirror such as an FSM or MEMS, and directing the multi-broadband combined beam from the imaging dichroic mirror at the steering mirror for controlled direction of the beam output, which may be further via an aperture, for example.

According to further aspects, the broadband multi-line laser may be configured to include a plurality of light sources or lasers each having respective different wavelengths, one or more first laser combining means configured to combine a first portion of the plurality of laser sources, at least a second laser combining means configured to combine the combined first portion of the laser sources and a remainder portion of the plurality of laser sources, wherein the second laser combining means is configured to combine differently from the one or more first laser combining means, and a steering mirror configured to receive and direct the combined first portion of the laser sources and the remainder portion of the plurality of laser sources for output emission. In aspects, the one or more first laser combining means may include one or more dichroic mirrors (e.g., 106, 114) or equivalents thereof. Additionally, in further aspects the second laser combing means may include an imaging dichroic mirror (e.g., 122, 206) or equivalents thereof. Moreover, the plurality of laser sources includes visible light laser sources and infrared (IR) laser sources. Yet further, the remainder portion of the plurality of laser sources comprises the IR laser sources, which may include one or more of LWIR, MWIR, and SWIR lasers.

In other examples, the apparatus 100 or 200 may be enclosed with an enclosure device or housing (not shown). The enclosure device or housing may further be configured for with a supply of dry nitrogen (or any suitable desiccant) that flows through the inside of the housing or enclosure device to mitigate moisture and regulate temperature, such as for outdoor uses of the multi broadband laser. The use of nitrogen or other desiccants helps to limit condensation on optics and the lasers, especially when the outside environment is high humidity (e.g., without the flow of dry nitrogen, the components could be damaged by the excess humidity).

As will be appreciated by those skilled in the art, the presently disclosed methods and apparatus provide the ability to use multiple lasers from different allocations of the electromagnetic spectrum at the same time in order to provide a resultant multi-spectral laser system. Because all the lasers emit from the same exit window and are overlapping, each beam propagates downrange to the same location. Accordingly, in some aspects, the present invention provides the ability to more easily “boresight align” any camera system to the single exit aperture of the lasers for pointing the multiple lasers downrange towards a “target” rather than having to boresight align a camera system to multiple different laser exit apertures.

Furthermore, the presently disclosed invention affords the ability to make several laser platforms smaller and/or require fewer laser windows for a system which can help to mask or hide the internal laser capabilities (i.e., it will be harder to ascertain what the laser system is capable of via visual inspection or imagery). Additionally, the presently disclosed invention helps to reduce the size, weight, and power for a beam director as there are fewer optical windows and optical paths for lasers to propagate through (i.e., instead of one path per EMS allocation, the present invention allows for one path for all lasers within a system). Moreover, the present invention mitigates issues such as optical alignments that may be bumped/changed when removing a laser from a test setup to put in a different laser. Instead, all the lasers may be setup and aligned for the test setup at the laboratory prior to the field testing, for example, and this eliminates the need to realign optics at an outdoor range.

Yet further, the presently disclosed invention may not require a specialty imaging dichroic mirror to be developed or designed as COTS dichroic mirrors designed for imaging/camera optics, but not designed for nor previously applied to or even suggested in the art to be applied to applications in laser physics, may suffice. Such imaging dichroic mirrors may be adapted for use in the presently disclosed apparatus as they have been shown to exhibit at least adequate performance for combining visible and IR light beams.

In yet other aspects, the presently disclosed apparatus and methods may be utilized for telecommunications where information/data can be stored within multiple laser wavelengths to increase the bandwidth of the data stream from one location to another. Still further uses may include the removal of the discrete/individual laser wavelengths to laser sources that are already emitting multiple wavelengths, and coaxially beam-combine those lasers using a same prototype system (optics/layout/equipment). In still further aspects, the presently disclosed apparatus and methods may include beam modulation and encoding, where the system has the ability to gate (i.e., turn on/off) individual laser beam paths to create an encoded laser signal down range (i.e., effecting telecommunications).

Furthermore, advanced Fast Steering Mirror (FSM) techniques used within the presently disclosed apparatus and methods may be utilized to provide the ability to rapidly move or raster the laser beam through physical space without having to move the multi broadband laser enclosure. Still further aspects may include beam-shaping techniques, such as with a MEMS (Micro-Electro-Mechanical System) mirror array to shape the exiting laser beam to form an image.

In still further aspects, the present apparatus allows for the coaxial beam combination of two broadband laser systems (i.e., one or more visible lasers from 400 nm-1000 nm, and one or more infrared lasers (e.g., approximately 1000 nm-5000 nm or even longer) via the use of an imaging dichroic mirror that was not intended for nor previously utilized for high optical power to be used on/through the surface of the mirror. Additionally, the present invention allows monochromatic lasers (i.e., traditional, non-broadband lasers) to be combined. It is noted further that the present invention is compatible with multiple laser types. Nonetheless, utilization of fiber optic lasers is beneficial for keeping the footprint of the multi broadband laser system smaller.

Additionally, fiber lasers may be utilized with the present apparatus allowing for placement of the laser module in a stationary location, which may be particularly advantageous when using lasers that are water-cooled, as one example. Moreover, an enclosure for the multi broadband laser system may be placed on a pan/tilt mounting without exceeding the pan/tilt balanced weight limits. Furthermore, the present invention may be a beneficial laboratory asset as it allows for combining of multiple high power lasers.

Although the present invention has been described in detail with reference to certain examples or embodiments, variations and modifications exist within the spirit and scope of the present invention as described and as defined in the following claims.

1. A broadband multi-line laser comprising:
a first mirror configured to reflect a first range of wavelengths of light and pass a second range of wavelengths of light such that light beams emitted from two light sources directed at the first mirror at incident angles approximately perpendicular to one another are additively combined and emitted from the first mirror;
a first laser light source aimed at the first mirror and configured to emit a first light beam at at least one first wavelength within the first range of wavelengths;
a second laser light source aimed at the first mirror at an angle approximately perpendicular to the first light source and configured to emit a second light beam at at least a second wavelength within the second range of wavelengths of light such that the first and second light beams combine into a combined light beam; and
a second mirror configured to receive and direct the combined light beam as an output emission by the broadband multi-line laser.

2. The broadband multi-line laser of claim 1, wherein the first mirror comprises an imaging dichroic mirror.

3. The broadband multi-line laser of claim 1, wherein the first laser light source comprises an infrared (IR) laser light source and the second laser light source comprises a visible or electro-optic (EO) laser light source.

4. The broadband multi-line laser of claim 3, wherein the IR laser light source includes at least one of a long wavelength infrared (LWIR) laser, a medium wavelength infrared (MWIR), or a short wavelength infrared (SWIR) laser.

5. The broadband multi-line laser of claim 1, wherein the second mirror comprises a fast steering mirror (FSM).

6. The broadband multi-line laser of claim 1, further comprising:
a control circuitry communicatively coupled to the first and second laser light sources and configured to control one or more of wavelength, modulation, and on/off operation of the first and second laser light sources.

7. The broadband multi-line laser of claim 1, further comprising:
a control circuitry communicatively coupled to the second mirror to control direction of the output emission of the broadband multi-line laser.

8. The broadband multi-line laser of claim 1, wherein the second mirror comprises a Micro-Electro-Mechanical System (MEMS) mirror array configured to beam shape the output emission of the broadband multi-line laser.

9. A multi broadband laser comprising:
at least a first dichroic mirror configured to additively combine light emitted from two or more visible or electro-optic (EO) light sources;
a first visible or EO light source and a second visible or EO light source both aimed at the at least one first dichroic mirror such that a first light beam from the at least a first visible or EO light source and a second light beam from a second visible or EO light source are additively combined into a first combined light beam;
a first imaging dichroic mirror configured to additively combine light emitted from visible or electro-optic (EO) light sources and at least one infrared light source and placed to receive at least the first combined light beam from the at least a first dichroic mirror; and
an infrared light source aimed at the first imaging dichroic mirror such that a third light beam emitted by the infrared light source is additively combined with the first combined light beam by the first imaging dichroic mirror to output a multi broadband laser beam.

10. The multi broadband laser of claim 9, wherein the infrared light source comprises at least one of a long wavelength infrared (LWIR) laser, a medium wavelength infrared (MWIR), or a short wavelength infrared (SWIR) laser.

11. The multi broadband laser of claim 9, further comprising:
a second mirror configured to receive the multi broadband laser beam and control direction of or raster the multi broadband laser beam.

12. The multi broadband laser of claim 11, wherein the second mirror comprises a fast steering mirror (FSM).

13. The multi broadband laser of claim 11, wherein the second mirror comprises a Micro-Electro-Mechanical System (MEMS) mirror array configured to beam shape the multi broadband laser beam.

14. The multi broadband laser of claim 11, further comprising:
a control circuitry communicatively coupled to the first visible or EO light source and the second visible or EO light source and configured to control one or more of wavelength, modulation, and on/off operation of the first and second visible or EO light sources.

15. The multi broadband laser of claim 14, further comprising:
the control circuitry communicatively coupled to the second mirror to control direction of the multi broadband laser beam.

16. The multi broadband laser of claim 9, further comprising:
at least a second dichroic mirror configured to additively combine light emitted from two or more visible or electro-optic (EO) light sources and disposed in a light path between the first dichroic mirror and the first imaging dichroic mirror, and further configured to receive the first combined light beam; and
a third visible or EO light source configured to direct a fourth light beam at the second dichroic mirror such that the first combined light beam and the fourth light beam are additively combined to generate a second combined light beam that is directed toward the first imaging dichroic mirror such that the second combined beam is additively combined with the third light beam from the infrared light source.

17. The multi broadband laser of claim 9, further comprising a housing that encloses a volume containing the at least a first dichroic mirror, the first and second visible or EO light sources, the first imaging dichroic mirror, and the infrared light source.

18. The multi broadband laser of claim 17, wherein the housing is further configured to include a desiccant within the volume.

19. A method for broadband multi-line laser transmission comprising:
directing at least one visible/EO laser beam from at least one visible/EO laser source toward at least one imaging mirror;
directing at least one broadband laser beam from at least one broadband IR laser source (e.g., SWIR, toward the at least one imaging mirror for additively combining the at least one visible/EO laser beam and the at least one broadband laser beam to form a resultant multi-broadband beam; and
outputting the resultant multi-broadband beam for transmission.

20. The method of claim 19, further comprising:
steering the resultant multi-broadband beam with a steering mirror.
